(19) United States
(12) Patent Application Publication
(10) Pub. No.: US 2025/0218044 A1
(43) Pub. Date: Jul. 3, 2025

(54) COLOR CLASSIFICATION METHOD AND APPARATUS, ELECTRONIC DEVICE AND STORAGE MEDIUM

(71) Applicant: Lemon Inc., Grand Cayman (KY)

(72) Inventors: Shen SANG, Los Angeles, CA (US); Xu WANG, Beijing (CN); Jing LIU, Los Angeles, CA (US); Peibin CHEN, Beijing (CN); Jingna SUN, Beijing (CN)

(21) Appl. No.: 18/853,397

(22) PCT Filed: Mar. 23, 2023
(86) PCT No.: PCT/SG2023/050191

§ 371 Date: Oct. 1, 2024

(30) Foreign Application Priority Data
Apr. 2, 2022 (CN) 202210351538.1

(51) Int. Cl. G06T 7/90

(52) U.S. Cl. CPC G06T 7/90; G06T 2207/10024

(57) ABSTRACT

Embodiments of the disclosure disclose a color classification method and apparatus, an electronic device and a storage medium. The color classification method including: determining, according to a first color numerical value of a color to be classified under a first color space, an initial category to which the color to be classified belongs, wherein the first color space includes a hue dimension; taking at least one sub-color category under the initial category as at least one candidate category; determining a target category of the color to be classified from the at least one candidate category according to a similarity of a second color numerical value of the color to be classified in a second color space with a third color numerical value of each of the at least one candidate category in the second color space.

The present application is a national phase application of International Patent Application No. PCT/SG2023/050191, filed on Mar. 23, 2023, which claims priority to Chinese Patent Application No. 202210351538.1, filed on Apr. 2, 2022, of the Chinese Patent Office, the entire content of which is incorporated herein by reference.

### TECHNICAL FIELD

Embodiments of the present application relate to the technical field of image processing, for example, to a color classification method, apparatus, electronic device and storage medium.

### BACKGROUND

A color classification method refers to a method of mapping a given color numerical value to a specific discrete color category. For example, color numerical values in the red-green-blue (RGB) color space are mapped into light blue, dark blue, etc. color categories.

In the related art, the color classification method is generally a deep learning based color classification. The disadvantages of the related art are at least that the large color numerical value combinations result in significant time and human resources for sample labeling, model training in the deep learning process, resulting in high training costs.

### SUMMARY

The embodiments of the present application provide a color classification method, apparatus, electronic device and storage medium, which can solve the problem of high training cost on the basis of guaranteeing color classification effect.

An embodiment of the present application provides a color classification method, including:
determining, according to a first color numerical value of a color to be classified under a first color space, an initial category to which the color to be classified belongs, wherein the first color space includes a hue dimension;
taking at least one sub-color category under the initial category as at least one candidate category;
determining a target category of the color to be classified from the at least one candidate category according to a similarity of a second color numerical value of the color to be classified in a second color space with a third color numerical value of each of the at least one candidate category in the second color space.

An embodiment of the present application further provides a color classification apparatus, including a first classification module, a candidate category determining module and a second classification module, the first classification module is configured to determine, according to a first color numerical value of a color to be classified under a first color space, an initial category to which the color to be classified belongs, wherein the first color space includes a hue dimension; the candidate category determining module is configured to take at least one sub-color category under the initial category as at least one candidate category; and the second classification module is configured to determine a target category of the color to be classified from the at least one candidate category according to a similarity of a second color numerical value of the color to be classified in a second color space with a third color numerical value of each of the at least one candidate category in the second color space.

An embodiment of the present application further provides an electronic device, including at least one processor and a storage device, a storage device is configured to store at least one program, and the at least one program, when executed by the at least one processor, causes the at least one processor to implement the color classification method according to any one of the embodiments of the present application.

An embodiment of the present application further provides a storage medium storing computer-executable instructions, wherein the computer-executable instructions, when executed by a computer processor, are used to execute the color classification method according to any one of the embodiments of the present application.

### BRIEF DESCRIPTION OF DRAWINGS

FIG. 1 is a flow diagram of a color classification method provided by an embodiment of the present application;

FIG. 2 is a two-stage block flow diagram of a color classification method provided by an embodiment of the present application;

FIG. 3 is a flow diagram of a color classification method provided by an embodiment of the present application;

FIG. 4 is a schematic structural diagram of a color classification apparatus provided by an embodiment of the present application;

FIG. 5 is a structural diagram of an electronic device provided by an embodiment of the present application.

### DETAILED DESCRIPTION

Embodiments of the present application will be described below with reference to the accompanying drawings. While some embodiments of the present application are illustrated in the accompanying drawings, it should be understood that the present application may be embodied in many forms and should not be construed as limited to the embodiments set forth herein, but rather, these embodiments are provided for a more thorough and complete understanding of the present application. It should be understood that the drawings and examples are for illustrative purposes only and are not intended to limit the scope of the present disclosure.

It should be understood that the various steps recited in the method implementation of the present application may be performed in a different order, and/or in parallel. Further, the method implementation may include additional steps and/or omit performing illustrated steps. The scope of the present application is not limited in this regard.

As used herein, the term “include” and variations thereof are open inclusion, that is, “including, but not limited to”. The term “based on” is “based at least in part on”. The term “one embodiment” means “at least one embodiment”. The term “another embodiment” means “at least one additional embodiment”. The term “some embodiments” means “at least some embodiments”. Relevant definitions for other terms will be given in the description below.

Note that the concepts of “first”, “second”, and the like mentioned in the present application are used only to distinguish different devices, modules, or units, and are not used to limit the order or interdependence of functions performed by these devices, modules, or units.

It is noted that the modifications referred to as “a” or “a plurality” in this application are illustrative rather than limiting, and those skilled in the art should understand that “one or more” should be understood unless the context clearly dictates otherwise.

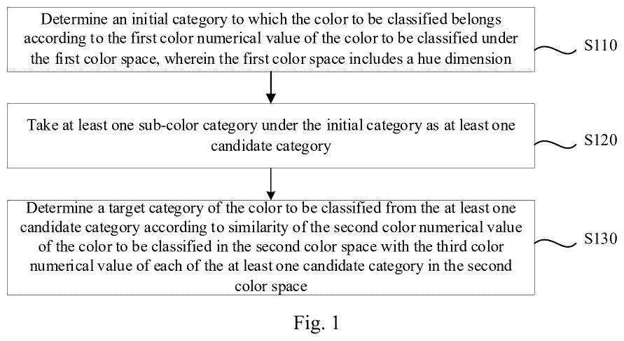

FIG. 1 is a flow diagram of a color classification method provided by an embodiment of the present application. Embodiments of the present application are applicable to classifying colors in an image. The method may be performed by a color classification apparatus, which may be implemented in the form of software and/or hardware, which may be configured in an electronic device, such as a computer.

As shown in FIG. 1, the present embodiment provides a color classification method including the following steps.

S110, determining an initial category to which the color to be classified belongs according to the first color numerical value of the color to be classified under the first color space, wherein the first color space includes a hue dimension.

In this embodiment, the color to be classified may be pixel color extracted from the to-be-processed image, and the to-be-processed image may be an image acquired in real time, an image stored in advance, or the like. The color to be classified may be expressed in color numerical values having different dimensions under different color spaces, and the first color numerical value may be considered to be the color numerical value of the color to be classified in the first color space.

Hue is very important for color expression, the first color space containing the hue dimension may be the Hue-Saturation-Value (HSV) color space, or may be the Hue-Saturation-Lightness (HSL) color space, etc., not exhaustive here. Since colors can be divided into dimensions such as hue, saturation, value/lightness in the first color space, colors can be expressed in a more natural and intuitive manner consistent with human color perception than a color space described by mixing hues such as Red-Green-Blue (RGB).

The initial category to which the color to be classified belongs may be considered to be the coarse classification of the color to be classified, i.e. the color gamut in which the color to be classified lies, which may for example be red, green, yellow or blue or the like. The target category of color to be classified as disclosed later may be considered to be a subcategory of color to be classified and may include, for example, pink, rose, bean green, peacock green, goose yellow, orange, light or dark blue, and the like. It may be understood that the target category of color to be classified is a sub-colorsub-color category of the initial category of the color to be classified. Illustratively, the initial category of color to be classified may be “blue”, the target category may be “light blue”, and the “light blue” category may be considered as a sub-color category of the “blue” category.

The initial classification may be determined by determining the initial category of the color to be classified based on the numerical value of the hue dimension in the first color numerical value, or based on the numerical value of the hue dimension and at least one other dimension in the first color numerical value.

In some optional implementations, the determining the initial category to which the color to be classified belongs according to the first color numerical value of the color to be classified under the first color space may include: determining, from a preset numerical value range corresponding to each of at least one dimension of the first color space, a target numerical value range to which each dimension numerical value of the first color numerical value belongs; the initial category to which the color to be classified belongs is determined based on the target numerical value range to which the at least one dimension numerical value belongs among the first color numerical value.

At least one preset numerical value range corresponding to each dimension under the first color space may be set in advance; It is also possible to set in advance the correspondence relationship between different range combinations of preset numerical value range to which at least one dimension corresponds and the initial category, i.e., the correspondence relationship of the range combination-the initial category.

In determining the initial category, for each dimension of the first color space, a numerical value range containing the corresponding dimension numerical value of the first color numerical value may be selected from a corresponding preset numerical value range, which may be considered as the target numerical value range to which the corresponding dimension numerical value of the first color numerical value belongs. After the target numerical value range to which the at least one dimension numerical value belongs in the first color numerical value is determined, the initial category corresponding to the combination of the at least one target numerical value range, i.e., the initial category to which the color to be classified belongs, may be determined according to the pre-set range combination-initial category correspondence.

By way of example, assuming that the first color numerical value of the color to be classified under HSV has a target value range to which the H-dimension value belongs of [115, 125], a target value range to which the S-dimension value belongs of [50, 90], and a target value range to which the V-dimension value belongs of [100, 255], it may be determined that the initial category corresponding to the combination of the three target value ranges is the “purple” category according to the pre-set range combination-initial category correspondence, that is, the initial category to which the color to be classified belongs is the “purple” category.

In these optional implementations, it may be achieved that the initial category is determined according to a target numerical value range to which the at least one dimension numerical value of the first color numerical values belongs.

S120, taking at least one sub-color category under the initial category as at least one candidate category.

At least one sub-color category corresponding to each initial category may be set in advance. After the initial category of color to be classified is determined, at least one sub-color category that belongs to the initial category may be considered as at least one candidate category. In some implementations, the candidate pool may be composed of at least one candidate category to facilitate the extraction of each candidate category from the candidate pool for similarity calculation with the color to be classified.

By determining the initial category based on the color numerical values under the first color space containing the hue dimension, other categories not belonging to the same color gamut can be excluded all, thereby advantageously guaranteeing consistency of the color classification result with human visual perception.

S130, determining a target category of the color to be classified from the at least one candidate category according to similarity of the second color numerical value of the color to be classified in the second color space with the third color numerical value of each of the at least one candidate category in the second color space.

The second color space may be the same as the first color space or may be different, and the second color space may include at least one of a red-green-blue (RGB) color space, a Hue-Saturation-Value (HSV) color space, a hue-saturation-lightness (HSL) color space, a color model (Lab) color space, and the like. The second color numerical value may be considered to be the color numerical value of the color to be classified in the second color space, and the third color numerical value may refer to the color numerical value of the at least one candidate category in the second color space.

A degree of similarity of the second color numerical value to the third color numerical value of each of the at least one candidate category in the second color space may be determined based on a dimension numerical value difference of each dimension in the second color numerical value and the third color numerical value of each of the at least one candidate category in the second color space, wherein the dimension numerical value difference of each dimension and the degree of similarity may be inversely related. This similarity may characterize the similarity of the color to be classified with at least one candidate category, and in turn the candidate category with the highest similarity may be taken as the target category.

By measuring the target category of the color to be classified according to the color numerical value from at least one candidate category belonging to the same initial category, it is possible to guarantee the consistency of the measurement result with the color to be classified in visual perception, and also avoid sample labeling, model training in the deep learning process, and solve the problem of high training cost.

In some optional implementations, the similarity is determined based on determining a similarity of the second color numerical value to the third color numerical value of each of the at least one candidate category in the second color space according to a Euclidean distance between the second color numerical value and the third color numerical value of each of the at least one candidate category in the second color space. The smaller the Euclidean distance, the more similar the color to be classified is to the candidate category, and the greater the degree of similarity.

Further, the similarity of the second color numerical value to the third color numerical value of each of the at least one candidate category in the second color space may also be determined based on at least one of a Euclidean distance, a Manhattan distance, a Chebyshev distance, and a Mahalanobis distance between the second color numerical value and the third color numerical value of each of the at least one candidate category in the second color space. And, when the kind of the distance includes two or more kinds, different weights may also be set for the distances of a plurality of kinds according to an empirical value or an experimental value to improve the accuracy rate of the similarity. And the smaller the weighted distance, the more similar the color to be classified and the candidate category can be considered.

In some implementations, determining the degree of similarity of the second color numerical value to the third color numerical value of each of the at least one candidate category in the second color space according to the Euclidean distance between the second color numerical value and the third color numerical value of each of the at least one candidate category in the second color space includes normalizing the Euclidean distance between the second color numerical value and the third color numerical value of each of the at least one candidate category in the second color space and determining the degree of similarity of the second color numerical value to the third color numerical value of each of the at least one candidate category in the second color space according to the normalization result.

In these optional implementations, it is advantageous to achieve a uniform color metric under different second color spaces by normalizing the Euclidean distances. In addition, when the kinds of distances include two or more kinds, the kinds of distances may be normalized to facilitate uniform color measurement of different kinds of distances. By normalizing the distance between the second color numerical value and the third color numerical value of each of the at least one candidate category in the second color space, the popularity of the color classification method can be improved.

In some optional implementations, before the determining the initial category to which the color to be classified belongs according to the first color numerical value of the color to be classified under the first color space may further include: acquiring the color numerical value of the color to be classified, determining a third color space of the acquired color numerical value; if the third color space does not belong to the first color space, the obtained color numerical value is converted into the first color space.

In these optional implementations, the third color space of the obtained color numerical value may be determined based on the meaning represented by each dimension in the obtained color numerical value. If the third color space contains a hue dimension, the third color space may be considered to belong to the first color space, and the obtained color numerical value may be considered to be the first color numerical value. If the third color space does not include a hue dimension, the third color space may be considered to not belong to the first color space, and the obtained color numerical value may be converted into the first color space according to a conversion relationship between the color spaces to obtain the first color numerical value. A foundation may thereby be laid for identifying the initial category of the color to be classified.

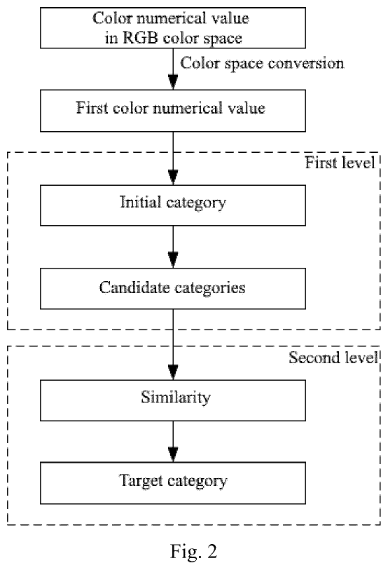

Illustratively, FIG. 2 is a two-level block flow diagram of a color classification method according to an embodiment of the present disclosure. Referring to FIG. 2, assuming that the obtained color numerical value of the color to be classified is a color numerical value in RGB color space, the first color numerical value may be obtained by color space conversion.

After determining the first color numerical value, a first level of coarse color classification may be performed, which may include, for example, first determining an initial category to which the color to be classified belongs based on a target numerical value range to which each dimension value of the first color numerical value belongs; the sub-color categories under the initial category are then taken as candidate categories.

After the at least one candidate category is determined, a second level of color subclassification may be performed, which may include, for example: determining a degree of similarity of the second color numerical value to the third color numerical value of each of the at least one candidate category in the second color space based on a dimension numerical value difference of each dimension in the second color numerical value and the third color numerical value of each of the at least one candidate category in the second color space; the target category of the color to be classified is then determined based on the similarity.

By transforming the color classification problem into a two-level classification problem, a two-level model structure can be constructed. The first level structure may coarse screen out the candidate categories, and the second level structure may get the target category of the color to be classified by the distance metric. This color classification method does not require complex data labeling and model training, nor does it rely heavily on the performance of the color distance metric algorithm.

The technical solution of an embodiment of the present application, according to the first color numerical value of the color to be classified under the first color space, determining the initial category to which the color to be classified belongs; the first color space contains a hue dimension; taking at least one sub-color category under the initial category as at least one candidate category; the target category of the color to be classified is determined from the at least one candidate category according to the similarity of the second color numerical value of the color to be classified in the second color space with the third color numerical value of each of the at least one candidate category in the second color space.

By initially classifying according to color numerical value under a color space including a hue dimension, it is possible to guarantee the consistency in visual perception of the color to be classified with the classification result; an accurate target category can be obtained by the similarity of the color numerical values of the candidate category under the initial category and the color to be classified in the same color space. This method avoids the process of sample labeling, model training in the existing deep learning process, and can solve the problem of high training cost.

### Example 2

Embodiments of the present application may be combined with various optional schemes in the color classification method provided in the above embodiments. The color classification method provided in this embodiment describes the step of determining the target category in the case where the second color space is at least two. By performing the synergy metric according to the similarity of the color to be classified and the at least one candidate category under different second color spaces, the accuracy of the color classification can be improved.

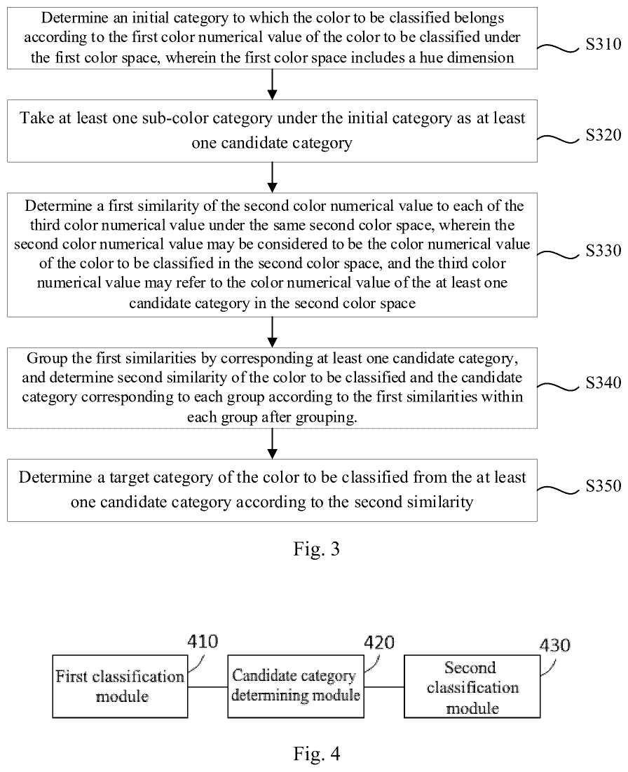

FIG. 3 is a flowchart illustrating a color classification method according to an embodiment of the present disclosure. As shown in FIG. 3, in some optional implementations, the second color space may include at least two color spaces, and the corresponding color classification method, may include the following steps.

S310, determining an initial category to which the color to be classified belongs according to the first color numerical value of the color to be classified under the first color space; the first color space includes a hue dimension.

S320, taking at least one sub-color category under the initial category as at least one candidate category.

S330, determining a first similarity of the second color numerical value to each of the third color numerical value under the same second color space; wherein the second color numerical value may be considered to be the color numerical value of the color to be classified in the second color space, and the third color numerical value may refer to the color numerical value of the at least one candidate category in the second color space.

Exemplarily, it is assumed that the candidate categories to which the color to be classified a correspond include a candidate category b and a candidate category c; the second color space includes an RGB color space, an HSV color space, and a Lab color space. A second color numerical value of the color to be classified a in the RGB color space, the HSV color space and the Lab color space, are representable as a_{R}, a_{H} and a_{L}, respectively; a third color numerical value of the candidate category b under the RGB color space, the HSV color space, and the Lab color space are representable as b_{R}, b_{H} and b_{L}, respectively; the third color numerical value of the candidate category c under the RGB color space, the HSV color space, and the Lab color space may be represented as c_{R}, c_{H} and c_{L}, respectively.

Then, determining a first similarity of the second color numerical value and each of the third color numerical values under the same second color space may include: determining a first similarity sₐ_{_{R}}_{c}_{_{R}} of the a_{R} and b_{R} and a first similarity sₐ_{_{R}}_{c}_{_{R}} of a_{R} and c_{R} for the RGB color space; determining a first similarity sₐ_{_{H}}_{b}_{_{H}} of a_{H} and b_{H} and a first similarity sₐ_{_{H}}_{c}_{_{H}} of a_{H} and c_{H} for the HSV color space; for the Lab color space, a first similarity sₐ_{_{L}}_{b}_{_{L}} of a_{L} and b_{L} is determined, and a first similarity sₐ_{_{L}}_{c}_{_{L}} of a_{L} and c_{L} is determined.

The degree of similarity of the second color numerical value to each of the third color numerical values may be determined based on the Euclidean distance between the second color numerical value and each of the third color numerical values. Also, the Euclidean distance may be normalized after it is determined to achieve a uniform color metric in different second color spaces.

S340. Grouping the first similarities by corresponding at least one candidate category, and determining second similarity of the color to be classified and the candidate category corresponding to each group according to the first similarities within each group after grouping.

Referring to an example of step S330, grouping the plurality of first similarities by corresponding candidate categories may include: dividing the first similarities sₐ_{_{R}}_{b}_{_{R}}, sₐ_{_{H}}_{b}_{_{H}} and sₐ_{_{L}}_{b}_{_{L}} by corresponding candidate category into Group 1; the first similarity sₐ_{_{R}}_{c}_{_{R}}, sₐ_{_{H}}_{c}_{_{H}} and sₐ_{_{L}}_{c}_{_{L}}, are divided into Group 2 by the corresponding candidate category c.

Accordingly, determining the second similarity of the color to be classified and the candidate category corresponding to each group according to the first similarity within each group may include: determining the second similarity S_{ab} of the color a to be classified and the candidate category b according to sₐ_{_{H}}_{b}_{_{H}}, sₐ_{_{L}}_{b}_{_{L}} and sₐ_{_{R}}_{b}_{_{R}} within the group for the group 1; determining a second similarity S_{ac} of the color to be classified a and the candidate category c according to the sₐ_{_{R}}_{c}_{_{R}}, sₐ_{_{H}}_{c}_{_{H}} and sₐ_{_{L}}_{c}_{_{L}} within the group for group 2.

In some optional implementations, determining the second similarity of the color to be classified and the candidate categories to which each group corresponds according to the first similarities within each group may include: determining a weight of the first similarity within each group according to the second color space to which the first similarity within each group corresponds; the first similarities within each group are weighted according to the weights, resulting in second similarity of the color to be classified and a candidate category corresponding to the each group.

Referring to an example of step S340, the determining of the weights of the first similarities within each group according to the second color spaces to which the first similarities within each group correspond may include that the second color spaces corresponding to sₐ_{_{R}}_{b}_{_{R}}, sₐ_{_{H}}_{b}_{_{H}} and sₐ_{_{L}}_{b}_{_{L}} within Group 1, respectively, are the RGB color space, the HSV color space, and the Lab color space. Since the three color spaces may be different in the size of influence on the classification result when performing the color metric, the weights of the corresponding sₐ_{_{R}}_{b}_{_{R}}, sₐ_{_{H}}_{b}_{_{H}}, and sₐ_{_{L}}_{b}_{_{L}} may be set according to the degree of importance of the three color spaces, respectively. Similarly, the weights of the corresponding sₐ_{_{R}}_{c}_{_{R}}, sₐ_{_{H}}_{c}_{_{H}} and sₐ_{_{L}}_{c}_{_{L}} within group 2 may be set separately.

The weight values of the first similarity corresponding to the same color space are generally the same. That is, the weight values of sₐ_{_{R}}_{b}_{_{R}} and sₐ_{_{R}}_{c}_{_{R}} are generally the same, the weight values of sₐ_{_{H}}_{b}_{_{H}} and sₐ_{_{H}}_{c}_{_{H}} are generally the same, and the weight values of sₐ_{_{L}}_{b}_{_{L}} and sₐ_{_{L}}_{c}_{_{L}} are generally the same. The weights of the first similarities corresponding to the different color spaces may be set according to empirical value or experimental value, for example, the weight of the first similarity corresponding to the RGB color space may be 0.3, the weight of the first similarity corresponding to the HSV color space may be 0.1, and the weight of the first similarity corresponding to the Lab color space may be 0.6.

In these optional implementations, after determining the first similarity weights within each group, the first similarities within each group may be weighted according to the weights, resulting in second similarity for the color to be classified and each group's corresponding candidate category.

In addition, the second degree of similarity may also be determined in other ways based on the maximum, minimum, median, etc. of the first similarities within each group, which is not exhaustive here.

S350, determining a target category of the color to be classified from the at least one candidate category according to the second similarity.

After determining the second similarity of the color to be classified and each group of corresponding candidate category, the candidate category to which the largest second similarity corresponds may be taken as the target category of the color to be classified.

The technical solution of the embodiment of the present application describes the step of determining the target category in the case where the second color space is at least two. The accuracy of the color classification can be further improved by performing the synergy metric according to the similarity of the color to be classified and the at least one candidate category under different second color spaces. Besides, the color classification method provided by the embodiment of the present application belongs to the same concept as the color classification method provided by the above embodiment, technical details that are not elaborately described in the present embodiment can be referred to the above embodiment.

### Example 3

FIG. 4 is a schematic structural diagram of a color classification apparatus according to an embodiment of the present application. The color classification apparatus provided by the present embodiment is suitable for the case of classifying colors in an image.

As shown in FIG. 4, the color classification apparatus provided by an embodiment of the present application may include: a first classification module 410 configured to determine an initial category to which the color to be classified belongs according to a first color numerical value of the color to be classified under a first color space; the first color space contains a hue dimension; a candidate category determining module 420 configured to take at least one sub-color category under the initial category as at least one candidate category; a second classification module 430 configured to determine a target category of the color to be classified from the at least one candidate category based on the second color numerical value of the color to be classified in the second color space and the third color numerical value of each of the at least one candidate category in the second color space

In some optional implementations, the color classification apparatus may further include: a conversion module configured to obtain the color numerical value of the color to be classified before determining the initial category to which the color to be classified belongs according to the first color numerical value of the color to be classified under the first color space, determine a third color space of the obtained color numerical value; when the third color space does not belong to the first color space, the obtained color numerical value is converted into the first color space.

In some optional implementations, the first classification module may be configured to: determine, from a preset numerical value range corresponding to each of the at least one dimension of the first color space, a target numerical value range to which a dimension numerical value of each dimension of the first color numerical value belongs; the initial category to which the color to be classified belongs is determined based on a target numerical value range to which dimension value of the at least one dimension of the first color numerical value belong.

In some optional implementations, the second classification module may determine the similarity based on the following steps: determining the similarity of the second color numerical value to the third color numerical value of each of the at least one candidate category in the second color space according to a Euclidean distance between the second color numerical value and the third color numerical value of each of the at least one candidate category in the second color space.

In some optional implementations, the second classification module may be configured to normalize the Euclidean distance between the second color numerical value and the third color numerical value of each of the at least one candidate category in the second color space, and determine the similarity of the second color numerical value to the third color numerical value of each of the at least one candidate category in the second color space according to the normalization result.

In some optional implementations, when the second color space includes at least two color spaces, the second classification module may determine the target category based on: determining a first similarity of the second color numerical value to each of the third color numerical values under the same second color space; grouping the first similarities by corresponding at least one candidate category, and determining second similarity of the colors to be classified and a candidate category corresponding to the each group according to the first similarities within each group after grouping; according to the second similarity, a target category of colors to be classified is determined from the at least one candidate category.

In some optional implementations, the second classification module may be configured to: determine weights of the first similarities within each group according to the second color space to which the first similarities within each group correspond; the first similarities within each group are weighted according to the weights, resulting in second similarity of the color to be classified and a candidate category corresponding to each group.

In some optional implementations, the second color space includes at least one of a red-green-blue color space, a hue-saturation-value color space, a hue-saturation-lightness color space, and a Lab color space.

The color classification apparatus provided by the embodiment of the application can execute the color classification method provided by any embodiment of the present application, and has a corresponding functional module for executing the method.

It is to be noted that a plurality of units and modules included in the above apparatus are divided only according to functional logic, but are not limited to the above division as long as the corresponding functions can be realized. In addition, the names of the plurality of functional units are also merely for convenience of distinguishing from each other, and are not used to limit the protection scope of the embodiments of the present application.

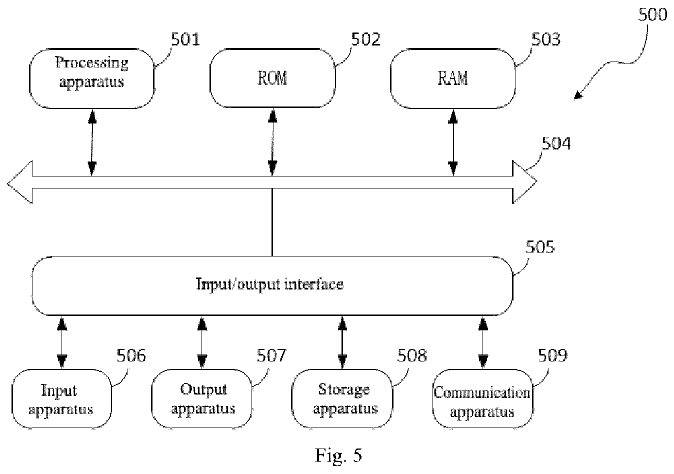

Reference is now made to FIG. 5, which shows a structural diagram of an electronic device (e.g., a terminal device or server in FIG. 5) 500 suitable for implementing embodiments of the present application. The terminal device in the embodiment of the present application may include, but is not limited to, a mobile terminal such as a mobile phone, a notebook computer, a digital broadcasting receiver, a Personal Digital Assistant (PDA), a tablet computer (PAD), a Portable Media Player (PMP), a vehicle-mounted terminal (e.g., a vehicle-mounted navigation terminal), and the like, and a fixed terminal such as a digital TV, a desktop computer, and the like. The electronic device illustrated in FIG. 5 is merely an example and is not intended to suggest any limitation as to the scope of use or functionality of the embodiments described herein.

As shown in FIG. 5, the electronic device 500 may include a processing device (e.g., a central processor, a graphics processor, etc.) 501 that may execute a variety of appropriate actions and processes in accordance with a program stored in a Read-Only Memory (ROM) 502 or a program loaded into a Random Access Memory (RAM) 503 from a storage device 508. In the RAM 503, various programs and data required for the operation of the electronic device 500 are also stored. The processing device 501, the ROM 502 and the RAM 503 are connected to each other by a bus 504. An Input/Output (I/O) interface 505 is also connected to the bus 504.

In general, the following devices may be connected to the I/O interface 505: input devices 506 including, for example, touchscreens, touchpads, keyboards, mice, cameras, microphones, accelerometers, gyroscopes, etc.; an output device 507 including, for example, a liquid crystal display (LCD), a speaker, a vibrator, or the like; storage 508 including, for example, magnetic tape, hard disk, etc.; and a communication device 509. The communication means 509 may allow the electronic device 500 to engage in wireless or wired communication with other devices to exchange data. While FIG. 5 illustrates electronic device 500 with various means, it should be understood that it is not required that all of the illustrated means be implemented or provided. More or fewer devices may optionally be implemented or provided.

According to an embodiment of the present application, the process described above with reference to the flowchart may be implemented as a computer software program. For example, embodiments of the present application include a computer program product including a computer program carried on a non-transitory computer readable medium, the computer program containing program code for performing the method illustrated by the flow chart. In such an embodiment, the computer program may be downloaded and installed from the network via the communication device 509, or installed from the storage device 506, or installed from the ROM 502. When the computer program is executed by the processing device 501, the above-described functions defined in the color classification method of the embodiments of the present application are performed.

The electronic device provided by the embodiment of the present application belongs to the same concept as the color classification method provided by the above embodiment, technical details that are not elaborately described in the present embodiment can be referred to the above embodiment.

An embodiment of the present application provides a computer storage medium having stored thereon a computer program which, when executed by a processor, implements the color classification method provided by the above embodiment.

It should be noted that the computer-readable medium described above may be a computer-readable signal medium or a computer-readable storage medium or any combination of both. A computer readable storage medium may be, for example, but not limited to, an electronic, magnetic, optical, electromagnetic, infrared, or semiconductor system, apparatus, or device, or any combination of the foregoing. Examples of a computer readable storage medium may include, but are not limited to, an electrical connection having one or more wires, a portable computer diskette, a hard disk, a RAM, a ROM, an Erasable Programmable Read-Only Memory (EPROM) or FLASH memory, an optical fiber, a portable Compact Disc Read-Only Memory (CD-ROM), an optical storage device, a magnetic storage device, or any suitable combination of the foregoing. In the present application, a computer readable storage medium may be any tangible medium that contains, or stores a program for use by or in connection with an instruction execution system, apparatus, or device. In the present application, a computer readable signal medium may include a propagated data signal with computer readable program code embodied therein, either in baseband or as part of a carrier wave. Such a propagated data signal may take many forms, including, but not limited to, an electromagnetic signal, an optical signal, or any suitable combination of the foregoing. A computer readable signal medium may also be any computer readable medium that is not a computer readable storage medium that can communicate, propagate, or transport a program for use by or in connection with an instruction execution system, apparatus, or device. Program code embodied on a computer readable medium may be transmitted using any appropriate medium, including but not limited to wireline, fiber optic cable, Radio Frequency (RF), etc., or any suitable combination of the foregoing.

In some implementation, clients, servers may communicate using any currently known or future developed network protocol, such as Hyper Text Transfer Protocol (HTTP), and may be interconnected with any form or medium of digital data communication (e.g., a communication network). Examples of communication networks include a Local Area Network (LAN), a Wide Area Network (WAN), an Internet (e.g., the Internet), and a peer-to-peer network (e.g., an ad hoc peer-to-peer network), as well as any currently known or future developed network.

The above-mentioned computer-readable medium may be included in the above-mentioned electronic device; it may also be present separately and not incorporated into the electronic device.

The computer readable medium carries one or more programs which, when executed by the electronic device, cause the electronic device to: determine an initial category to which the color to be classified belongs based on a first color numerical value of the color to be classified in a first color space; the first color space contains a hue dimension; take at least one sub-color category under the initial category as at least one candidate category; the target category of the color to be classified is determined from the at least one candidate category according to the similarity of the second color numerical value of the color to be classified in the second color space with the third color numerical value of each of the at least one candidate category in the second color space.

Computer program code for carrying out operations of the present application may be written in one or more programming languages or combinations thereof, including without limitation an object oriented programming language such as Java, Smalltalk, C++ and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the scenario involving a remote computer, the remote computer may be connected to the user's computer through any type of network, including a LAN or a WAN, or the connection may be made to an external computer (for example, through the Internet using an Internet Service Provider).

The flowchart and block diagrams in the Figures illustrate the architecture, functionality, and operation of possible implementations of systems, methods, and computer program products according to various embodiments of the present application. In this regard, each block in the flowchart or block diagrams may represent a module, segment, or portion of code, which includes one or more executable instructions for implementing the specified logical function(s). It should also be noted that, in some optional implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or operations or combinations of special purpose hardware and computer instructions.

The units described in the embodiments of the present application may be implemented by means of software or by means of hardware wherein the names of the units or modules do not in some cases constitute limitations on the units or modules themselves.

The functionality described above herein can be performed, at least in part, by one or more hardware logic components. For example, without limitation, illustrative types of hardware logic components that can be used include Field-programmable Gate Arrays (FPGAs), Application Specific Integrated Circuits (ASICs), Application Specific Standard Parts (ASSPs), System on Chip (SOCs), Complex Programmable Logic Devices (CPLDs), etc.

In the context of the present application, a machine readable medium may be a tangible medium that can contain, or store a program for use by or in connection with an instruction execution system, apparatus, or device. The machine readable medium may be a machine readable signal medium or a machine readable storage medium. A machine readable medium may include, but is not limited to, an electronic, magnetic, optical, electromagnetic, infrared, or semiconductor system, apparatus, or device, or any suitable combination of the foregoing. Examples of the machine readable storage medium would include an electrical connection based on one or more wires, a portable computer diskette, a hard disk, RAM, ROM, EPROM or Flash memory, an optical fiber, a CD-ROM, an optical storage device, a magnetic storage device, or any suitable combination of the foregoing.

According to one or more embodiments of the present application provide a color classification method including: determining, according to a first color numerical value of a color to be classified under a first color space, an initial category to which the color to be classified belongs, wherein the first color space includes a hue dimension; taking at least one sub-color category under the initial category as at least one candidate category; determining a target category of the color to be classified from the at least one candidate category according to a similarity of a second color numerical value of the color to be classified in a second color space with a third color numerical value of each of the at least one candidate category in the second color space.

According to one or more embodiments of the present application provide a color classification method, further including:

In some alternative implementations, before the determining, according to a first color numerical value of a color to be classified under a first color space, an initial category to which the color to be classified belongs, further including: obtaining color numerical value of the color to be classified, and determining a third color space of an obtained color numerical value; converting the obtained color numerical value into the first color space in a case where the third color space does not belong to the first color space.

According to one or more embodiments of the present application provide a color classification method, further including:

In some alternative implementations, the determining, according to a first color numerical value of a color to be classified under a first color space, an initial category to which the color to be classified belongs includes: determining, from a preset numerical value range corresponding to each dimension of at least one dimension of the first color space, a target numerical value range to which a dimension numerical value of the each dimension of the first color numerical value belongs; determining the initial category to which the color to be classified belongs according to the target numerical value range to which the dimension numerical value of the each dimension of the first color numerical value belongs.

According to one or more embodiments of the present application provide a color classification method, further including:

In some alternative implementations, determining the similarity includes: determining the similarity of the second color numerical value to a third color numerical value of each of the at least one candidate category in the second color space according to an Euclidean distance between the second color numerical value and the third color numerical value of each of the at least one candidate category in the second color space.

According to one or more embodiments of the present application provide a color classification method, further including:

In some alternative implementations, the determining the similarity of the second color numerical value to a third color numerical value of each of the at least one candidate category in the second color space according to an Euclidean distance between the second color numerical value and the third color numerical value of each of the at least one candidate category in the second color space includes: normalizing the Euclidean distance between the second color numerical value and the third color numerical value of each of the at least one candidate category under the second color space, and determining the similarity of the second color numerical value to the third color numerical value of each of the at least one candidate category under the second color space according to a normalization result.

According to one or more embodiments of the present application provide a color classification method, further including:

In some alternative implementations, in a case that the second color space includes at least two, determining the target category of the color to be classified includes: determining a first similarity of the second color numerical value to each third color numerical value under a same second color space; grouping the first similarity by a corresponding at least one candidate category, and determining a second similarity of the color to be classified and a candidate category corresponding to each group according to first similarities within the each group after grouping; determining the target category of the color to be classified from the at least one candidate category according to the second similarity.

According to one or more embodiments of the present application provide a color classification method, further including:

In some alternative implementations, the determining a second similarity of the color to be classified and a candidate category corresponding to each group according to first similarities within the each group after grouping includes: determining weights of the first similarities within the each group according to a second color space to which the first similarities within the each group correspond; and weighting the first similarities within the each group according to the weights, resulting in the second similarity of the color to be classified and a candidate category corresponding to the each group.

According to one or more embodiments of the present application provide a color classification method, further including:

In some alternative implementations, the second color space includes at least one of a red-green-blue color space, a hue-saturation-value color space, a hue-saturation-lightness color space, and a color model (Lab) color space.

The above description is merely exemplary of the present application and illustrative of the principles of the technology employed. It should be understood by those skilled in the art that the scope of the disclosure referred to in the present application is not limited to the technical solution formed by the specific combination of the above technical features, but also covers other technical solutions formed by any combination of the above technical features or their equivalent features without departing from the above concept. For example, the above-described features may be substituted with the features disclosed in the present application (but not limited to) having similar functions.

Further, while operations are depicted in a particular order, this should not be understood as requiring that these operations be performed in the particular order shown or in sequential order. In certain circumstances, multitasking and parallel processing may be advantageous. Likewise, while numerous implementation details are contained in the above discussion, these should not be construed as limitations on the scope of the present application. Some features that are described in the context of separate embodiments can also be implemented in combination in a single embodiment. Conversely, various features that are described in the context of a single embodiment can also be implemented in multiple embodiments separately or in any suitable subcombination.

1. A color classification method, comprising:
determining, according to a first color numerical value of a color to be classified under a first color space, an initial category to which the color to be classified belongs, wherein the first color space comprises a hue dimension;
taking at least one sub-color category under the initial category as at least one candidate category; and
determining a target category of the color to be classified from the at least one candidate category according to a similarity of a second color numerical value of the color to be classified in a second color space with a third color numerical value of each of the at least one candidate category in the second color space.

2. The method of claim 1, before the determining, according to a first color numerical value of a color to be classified under a first color space, an initial category to which the color to be classified belongs, further comprising:
obtaining color numerical value of the color to be classified, and determining a third color space of an obtained color numerical value; and
converting the obtained color numerical value into the first color space in a case where the third color space does not belong to the first color space.

3. The method of claim 1, wherein the determining, according to a first color numerical value of a color to be classified under a first color space, an initial category to which the color to be classified belongs comprises:
determining, from a preset numerical value range corresponding to each dimension of at least one dimension of the first color space, a target numerical value range to which a dimension numerical value of the each dimension of the first color numerical value belongs; and
determining the initial category to which the color to be classified belongs according to the target numerical value range to which the dimension numerical value of the each dimension of the first color numerical value belongs.

4. The method of claim 1, wherein determining the similarity comprises:
determining the similarity of the second color numerical value to a third color numerical value of each of the at least one candidate category in the second color space according to an Euclidean distance between the second color numerical value and the third color numerical value of each of the at least one candidate category in the second color space.

5. The method of claim 4, wherein the determining the similarity of the second color numerical value to a third color numerical value of each of the at least one candidate category in the second color space according to an Euclidean distance between the second color numerical value and the third color numerical value of each of the at least one candidate category in the second color space comprises:
normalizing the Euclidean distance between the second color numerical value and the third color numerical value of each of the at least one candidate category under the second color space, and determining the similarity of the second color numerical value to the third color numerical value of each of the at least one candidate category under the second color space according to a normalization result.

6. The method according to claim 1, wherein in a case that the second color space comprises at least two, determining the target category of the color to be classified comprises:
determining a first similarity of the second color numerical value to each third color numerical value under a same second color space;
grouping the first similarity by a corresponding at least one candidate category, and determining a second similarity of the color to be classified and a candidate category corresponding to each group according to first similarities within the each group after grouping; and
determining the target category of the color to be classified from the at least one candidate category according to the second similarity.

7. The method of claim 6, wherein the determining a second similarity of the color to be classified and a candidate category corresponding to each group according to first similarities within the each group after grouping comprises:
determining weights of the first similarities within the each group according to a second color space to which the first similarities within the each group correspond; and
weighting the first similarities within the each group according to the weights, resulting in the second similarity of the color to be classified and a candidate category corresponding to the each group.

8. The method of claim 1, wherein the second color space comprises at least one of a red-green-blue color space, a hue-saturation-value color space, a hue-saturation-lightness color space, and a color model (Lab) color space.

9. A color classification apparatus, comprising:
a first classification module, configured to determine, according to a first color numerical value of a color to be classified under a first color space, an initial category to which the color to be classified belongs, wherein the first color space comprises a hue dimension;
a candidate category determining module, configured to take at least one sub-color category under the initial category as at least one candidate category; and
a second classification module, configured to determine a target category of the color to be classified from the at least one candidate category according to a similarity of a second color numerical value of the color to be classified in a second color space with a third color numerical value of each of the at least one candidate category in the second color space.

10. An electronic device, comprising:
at least one processor;
a storage device configured to store at least one program,
the at least one program, when executed by the at least one processor, causes the at least one processor to implement the color classification method of claim 1.

11. A non-transitory computer-readable storage medium storing computer-executable instructions, wherein the computer-executable instructions, when executed by a computer processor, are used to execute a color classification method, wherein the color classification method comprises:
determining, according to a first color numerical value of a color to be classified under a first color space, an initial category to which the color to be classified belongs, wherein the first color space comprises a hue dimension;
taking at least one sub-color category under the initial category as at least one candidate category; and
determining a target category of the color to be classified from the at least one candidate category according to a similarity of a second color numerical value of the color to be classified in a second color space with a third color numerical value of each of the at least one candidate category in the second color space.

12. The color classification apparatus of claim 9, wherein the color classification apparatus further comprises a conversion module, and the conversion module configured to, before the determining, according to a first color numerical value of a color to be classified under a first color space, an initial category to which the color to be classified belongs, perform the following steps:
obtaining color numerical value of the color to be classified, and determining a third color space of an obtained color numerical value; and
converting the obtained color numerical value into the first color space in a case where the third color space does not belong to the first color space.

13. The color classification apparatus of claim 9, wherein the determining, according to a first color numerical value of a color to be classified under a first color space, an initial category to which the color to be classified belongs comprises:
determining, from a preset numerical value range corresponding to each dimension of at least one dimension of the first color space, a target numerical value range to which a dimension numerical value of the each dimension of the first color numerical value belongs; and
determining the initial category to which the color to be classified belongs according to the target numerical value range to which the dimension numerical value of the each dimension of the first color numerical value belongs.

14. The non-transitory computer-readable storage medium of claim 11, before the determining, according to a first color numerical value of a color to be classified under a first color space, an initial category to which the color to be classified belongs, further comprising:
obtaining color numerical value of the color to be classified, and determining a third color space of an obtained color numerical value; and
converting the obtained color numerical value into the first color space in a case where the third color space does not belong to the first color space.

15. The non-transitory computer-readable storage medium of claim 11, wherein the determining, according to a first color numerical value of a color to be classified under a first color space, an initial category to which the color to be classified belongs comprises:
determining, from a preset numerical value range corresponding to each dimension of at least one dimension of the first color space, a target numerical value range to which a dimension numerical value of the each dimension of the first color numerical value belongs; and
determining the initial category to which the color to be classified belongs according to the target numerical value range to which the dimension numerical value of the each dimension of the first color numerical value belongs.

16. The non-transitory computer-readable storage medium of claim 11, wherein determining the similarity comprises:
determining the similarity of the second color numerical value to a third color numerical value of each of the at least one candidate category in the second color space according to an Euclidean distance between the second color numerical value and the third color numerical value of each of the at least one candidate category in the second color space.

17. The non-transitory computer-readable storage medium of claim 16, wherein the determining the similarity of the second color numerical value to a third color numerical value of each of the at least one candidate category in the second color space according to an Euclidean distance between the second color numerical value and the third color numerical value of each of the at least one candidate category in the second color space comprises:
normalizing the Euclidean distance between the second color numerical value and the third color numerical value of each of the at least one candidate category under the second color space, and determining the similarity of the second color numerical value to the third color numerical value of each of the at least one candidate category under the second color space according to a normalization result.

18. The non-transitory computer-readable storage medium according to claim 11, wherein in a case that the second color space comprises at least two, determining the target category of the color to be classified comprises:
determining a first similarity of the second color numerical value to each third color numerical value under a same second color space;
grouping the first similarity by a corresponding at least one candidate category, and determining a second similarity of the color to be classified and a candidate category corresponding to each group according to first similarities within the each group after grouping; and
determining the target category of the color to be classified from the at least one candidate category according to the second similarity.

19. The non-transitory computer-readable storage medium of claim 18, wherein the determining a second similarity of the color to be classified and a candidate category corresponding to each group according to first similarities within the each group after grouping comprises:
determining weights of the first similarities within the each group according to a second color space to which the first similarities within the each group correspond; and
weighting the first similarities within the each group according to the weights, resulting in the second similarity of the color to be classified and a candidate category corresponding to the each group.

20. The non-transitory computer-readable storage medium of claim 11, wherein the second color space comprises at least one of a red-green-blue color space, a hue-saturation-value color space, a hue-saturation-lightness color space, and a color model (Lab) color space.
